(19) United States
(12) Patent Application Publication
(10) Pub. No.: US 2011/0012938 A1
(43) Pub. Date: Jan. 20, 2011

(54) DRIVING METHOD OF PLASMA DISPLAY DEVICE

(75) Inventor: Kazuhiro Yamada, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/865,155

(22) PCT Filed: Dec. 10, 2009
(86) PCT No.: PCT/JP2009/006738

§ 371 Date: Jul. 29, 2010

(30) Foreign Application Priority Data
Dec. 11, 2008 (JP) 2008-315355 2008

(51) Int. Cl. G09G 5/10; G09G 3/28

(52) U.S. Cl. 345/690; 345/60

(57) ABSTRACT

The driving method of the plasma display device has a plurality of combination sets for display that include a different number of combinations. The signal levels of a red image signal, a green image signal, and a blue image signal are compared with each other. For an image signal of a color that has a relatively low signal level, a combination set for display is used where the number of combinations is smaller than that in the combination set for display used for an image signal of a color that has a relatively high signal level. When the power consumption of a data electrode driving circuit is large, a combination set for display is used where the number of combinations is smaller than that in a combination set for display used for an image signal when the power consumption of the data electrode driving circuit is small.

This application is a U.S. National Phase Application of PCT International Application PCT/JP2009/006738.

### TECHNICAL FIELD

The present invention relates to a driving method of a plasma display device using an alternating-current (AC) type plasma display panel.

### BACKGROUND ART

A plasma display panel (hereinafter referred to as “panel”) typical as an image display device that has many pixels arranged in a plane shape has many discharge cells that have a scan electrode, a sustain electrode, and a data electrode. The panel excites a phosphor to emit light with gas discharge that is generated inside each discharge cell, and performs color display.

A plasma display device using such a panel mainly employs a subfield method as a method of displaying an image. In this method, one field period is formed of a plurality of subfields having a predetermined luminance weight, and an image is displayed by controlling light emission or no light emission in each discharge cell in each subfield.

The plasma display device has a scan electrode driving circuit for driving a scan electrode, a sustain electrode driving circuit for driving a sustain electrode, and a data electrode driving circuit for driving a data electrode. The driving circuit of each electrode of the plasma display device applies a required driving voltage waveform to each electrode. The data electrode driving circuit, based on an image signal, independently applies an address pulse for address operation to each of many data electrodes.

When the panel is seen from the side of the data electrode driving circuit, each data electrode serves as a capacitive load having a stray capacitance between it and an adjacent data electrode, scan electrode, and sustain electrode. Therefore, in order to apply a driving voltage waveform to each data electrode, charge and discharge of this capacitance must be required. As a result, the data electrode driving circuit requires power consumption for the charge and discharge.

The power consumption of the data electrode driving circuit increases as charge/discharge current of the capacitance possessed by the data electrode increases. This charge/discharge current largely depends on an image signal to be displayed. For instance, when an address pulse is applied to no data electrode, the charge/discharge current becomes “0” and hence the power consumption becomes minimum. Also when an address pulse is applied to all data electrodes, the charge/discharge current becomes “0” and hence the power consumption is small. When an address pulse is applied to data electrodes in a random fashion, the charge/discharge current becomes large and hence the power consumption also becomes large.

As a method of reducing the power consumption of the data electrode driving circuit, the following method or the like is disclosed. In this method, the power consumption of the data electrode driving circuit is calculated based on an image signal, for example. When the power consumption is large, an address operation is prohibited firstly in the subfield of the smallest luminance weight to restrict the power consumption of the data electrode driving circuit (for example, patent literature 1). Alternatively, a method or the like of decreasing the power consumption of the data electrode driving circuit by replacing an original image signal with an image signal for decreasing the power consumption of the data electrode driving circuit is disclosed (for example, patent literature 2).

The methods of patent literatures 1 and 2 are mainly used for preventing the plasma display device from failing when the power consumption excessively increases. Therefore, the methods of patent literatures 1 and 2 can largely damage the image display quality.

Recently, the power consumption of the data electrode driving circuit has steadily increased in response to enlargement in screen and enhancement in definition. Therefore, a power reducing method capable of being steadily used without sacrificing the image display quality has been demanded.

### CITATION LIST

[Patent Literature]

[Patent Literature 1] Unexamined Japanese Patent Publication No. 2000-66638

[Patent Literature 2] Unexamined Japanese Patent Publication No. 2002-149109

### SUMMARY OF THE INVENTION

A driving method of a plasma display device of the present invention employs a panel having a plurality of discharge cells having a data electrode, and a data electrode driving circuit for applying an address pulse for controlling the light emission or no light emission in a discharge cell to the data electrode. The driving method of the plasma display device has the following steps:

constituting one field period by a plurality of subfields of a predetermined luminance weight;

selecting a plurality of combinations from arbitrary combinations of the subfields and creating a combination set for display; and

displaying gradation by controlling the light emission or no light emission in a discharge cell using a combination of the subfields belonging to the combination set for display.

The driving method of the plasma display device has the following steps. A plurality of combination sets for display having a different number of combinations is provided, and signal levels of a red image signal, a green image signal, and a blue image signal are compared with each other. For an image signal of a color that has a relatively low signal level, a combination set for display is used where the number of combinations is smaller than that in the combination set for display used for an image signal of a color that has a relatively high signal level. When the power consumption of the data electrode driving circuit is large, a combination set for display is used where the number of combinations is smaller than that in the combination set for display used for an image signal when the power consumption of the data electrode driving circuit is small.

This method can provide a driving method of the plasma display device capable of reducing the power consumption of the data electrode driving circuit without sacrificing the image display quality.

A driving method of a plasma display device of the present invention employs a panel having a plurality of discharge cells having a data electrode, and a data electrode driving circuit for driving the data electrode. The driving method of the plasma display device has the following steps:

constituting one field period by a plurality of subfields of a predetermined luminance weight;

selecting a plurality of combinations from arbitrary combinations of the subfields and creating a combination set for display; and

displaying gradation by controlling the light emission or no light emission in a discharge cell using a combination of the subfields belonging to the combination set for display.

The driving method of the plasma display device has the following steps. A plurality of combination sets for display having a different number of combinations is provided, and spatial difference of each of a red image signal, a green image signal, and a blue image signal is calculated. For an image signal of a large spatial difference, a combination set for display is used where the number of combinations is smaller than that in the combination set for display used for an image signal of a small spatial difference. When the power consumption of the data electrode driving circuit is large, a combination set for display may be used where the number of combinations is smaller than that in the combination set for display used for an image signal when the power consumption of the data electrode driving circuit is small.

In the driving method of the plasma display device of the present invention, preferably, the average value of hamming distances between certain gradations and the next smaller gradations in a combination set for display that has a small number of combinations is smaller than that in a combination set for display that has a large number of combinations.

In the driving method of the plasma display device of the present invention, preferably, for an image signal for displaying a moving image, a combination set for display is used where the number of combinations is smaller than that in the combination set for display used for the image signal for displaying a still image.

### BRIEF DESCRIPTION OF DRAWINGS

FIG. 1 is an exploded perspective view showing a structure of a panel of a plasma display device in accordance with a first exemplary embodiment of the present invention.

FIG. 2 is an electrode array diagram of the panel of the plasma display device.

FIG. 3 is a circuit block diagram of the plasma display device.

FIG. 4 is a diagram showing a driving voltage waveform of the plasma display device.

FIG. 5A is a diagram showing a coding table used in the plasma display device.

FIG. 5B is a diagram showing another coding table used in the plasma display device.

FIG. 5C is a diagram showing yet another coding table used in the plasma display device.

FIG. 5D is a diagram showing still another coding table used in the plasma display device.

FIG. 6 is a diagram showing a relationship between the maximum value of the power consumption of a data driver and a constant in the plasma display device.

FIG. 7 is a schematic diagram showing the selective use of the coding tables of the plasma display device.

FIG. 8 is a circuit block diagram showing the detail of an image signal processing circuit of the plasma display device.

FIG. 9 is a circuit block diagram of a power predicting section of the plasma display device.

FIG. 10A is a diagram showing a coding table used in a plasma display device in accordance with a second exemplary embodiment of the present invention.

FIG. 10B is a diagram showing another coding table used in the plasma display device in accordance with the second exemplary embodiment.

FIG. 10C is a diagram showing yet another coding table used in the plasma display device in accordance with the second exemplary embodiment.

FIG. 10D is a diagram showing still another coding table used in the plasma display device in accordance with the second exemplary embodiment.

FIG. 10E is a diagram showing still another coding table used in the plasma display device in accordance with the second exemplary embodiment.

FIG. 10F is a diagram showing still another coding table used in the plasma display device in accordance with the second exemplary embodiment.

FIG. 11A is a diagram showing an example of a display image of the plasma display device.

FIG. 11B is a diagram showing a differential signal of an example of a display image of the plasma display device.

FIG. 12 is a diagram showing the selective use of the coding tables for an image signal of the plasma display device.

FIG. 13 is a diagram showing a relationship between the highest value of the power consumptions of data drivers and constants in the plasma display device.

FIG. 14 is a diagram showing another relationship between the highest value of the power consumptions of the data drivers and the constants in the plasma display device.

FIG. 15 is a circuit block diagram showing the detail of an image signal processing circuit of the plasma display device.

FIG. 16 is a circuit block diagram showing R data converting section, G data converting section, and B data converting section of the plasma display device.

### DETAILED DESCRIPTION OF PREFERRED EMBODIMENTS

### First Exemplary Embodiment

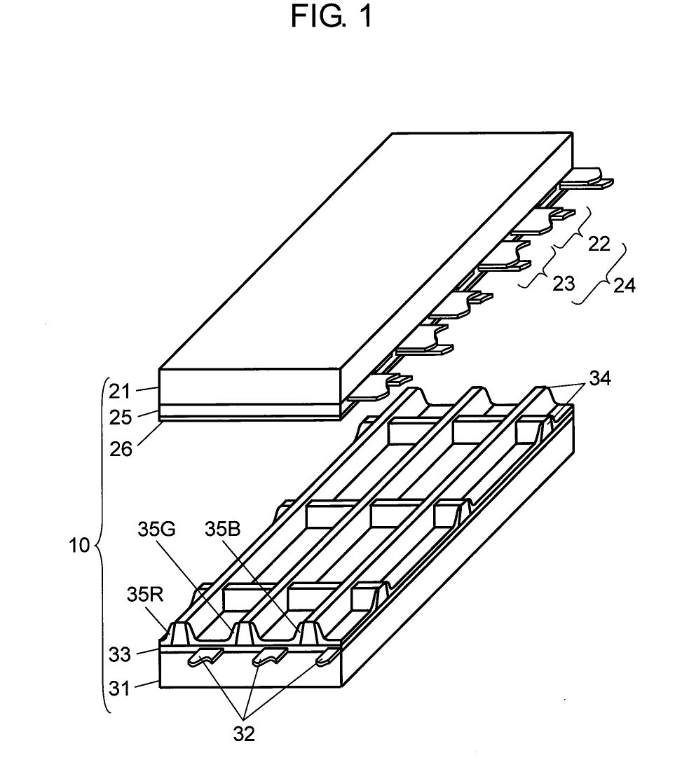

A plasma display device in accordance with exemplary embodiments of the present invention will be described hereinafter with reference to the accompanying drawings. FIG. 1 is an exploded perspective view showing a structure of panel 10 of the plasma display device in accordance with the first exemplary embodiment of the present invention. A plurality of display electrode pairs 24 formed of scan electrodes 22 and sustain electrodes 23 is disposed on glass-made front substrate 21. Dielectric layer 25 is formed so as to cover display electrode pairs 24, and protective layer 26 is formed on dielectric layer 25. A plurality of data electrodes 32 is formed on rear substrate 31, dielectric layer 33 is formed so as to cover data electrodes 32, and mesh barrier ribs 34 are formed on dielectric layer 33. Phosphor layer 35R for emitting red light, phosphor layer 35G for emitting green light, and phosphor layer 35B for emitting blue light are formed on the side surfaces of barrier ribs 34 and on dielectric layer 33.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example. The discharge space is partitioned into a plurality of sections by barrier ribs 34. Discharge cells are formed in the intersecting parts of display electrode pairs 24 and data electrodes 32. The discharge cells discharge and emit light to display an image.

The structure of panel 10 is not limited to the above-mentioned one, but may have striped barrier ribs, for example.

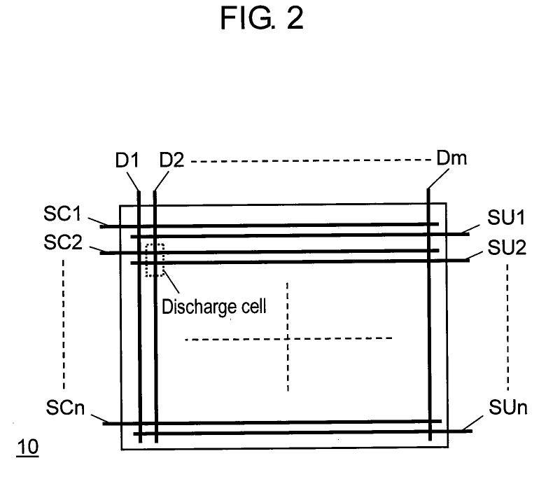

FIG. 2 is an electrode array diagram of panel 10 of the plasma display device in accordance with the first exemplary embodiment of the present invention. Panel 10 has n scan electrodes SC1 through SCn (scan electrodes 22 in FIG. 1) and n sustain electrodes SU1 through SUn (sustain electrodes 23 in FIG. 1) both extended in the row direction, and m data electrodes D1 through Dm (data electrodes 32 in FIG. 1) extended in the column direction. A discharge cell is formed in the part where a pair of scan electrode SCi (i is 1 through n) and sustain electrode SUi intersect with one data electrode Dj (j is 1 through m). Thus, m×n discharge cells are formed in the discharge space. Three adjacent discharge cells, which are a discharge cell having red phosphor layer 35R, a discharge cell having green phosphor layer 35G, and a discharge cell having blue phosphor layer 35B, correspond to one pixel when an image is displayed. Therefore, m/3×n sets of pixels are formed on panel 10. An pixel at a pixel position (x, y) on the display screen is constituted by three discharge cells formed in parts where scan electrodes SCy and sustain electrodes SUy intersect with three data electrodes D3x-2, D3x-1, and D3x. Here, x is 1 to m/3 and y is 1 to n.

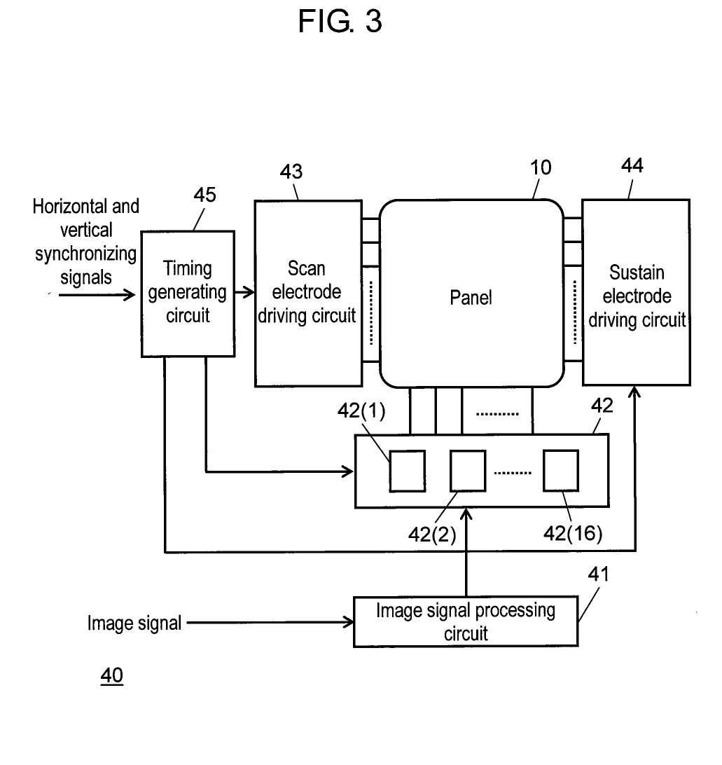

FIG. 3 is a circuit block diagram of plasma display device 40 in accordance with the first exemplary embodiment of the present invention. Plasma display device 40 has the following elements:

panel 10;

image signal processing circuit 41;

data electrode driving circuit 42;

scan electrode driving circuit 43;

sustain electrode driving circuit 44;

timing generating circuit 45; and

a power supply circuit (not shown) for supplying power required for each circuit block.

Image signal processing circuit 41 converts an input image signal into an image signal of each color having the number of pixels and the number of gradations that can be displayed on panel 10 (the detail is described later). Image signal processing circuit 41 converts the light emission and no light emission of a discharge cell in each subfield into image data of each color corresponding to bits “1” and “0” of a digital signal.

Data electrode driving circuit 42 converts the image data output from image signal processing circuit 41 into an address pulse corresponding to each of data electrodes D1 through Dm, and applies the address pulse to each of data electrodes D1 through Dm. Data electrode driving circuit 42 is formed of a plurality of exclusive ICs (hereinafter referred to as “data drivers”) because it needs to independently drive many data electrodes D1 through Dm based on the image data. In the present embodiment, the number (m) of data electrodes is “4000”, the number of outputs of one data driver is “250”, and data electrode driving circuit 42 is formed using 16 data drivers 42(1) through 42(16). However, the present invention is not limited to the number of data electrodes, or the number of outputs of the data drivers.

Timing generating circuit 45 generates various timing signals for controlling operations of respective circuit blocks based on a horizontal synchronizing signal and a vertical synchronizing signal, and supplies them to respective circuit blocks. Scan electrode driving circuit 43 and sustain electrode driving circuit 44 generate driving voltage waveforms based on respective timing signals, and apply the waveforms to scan electrodes SC1 through SCn and sustain electrodes SU1 through SUn.

Next, driving voltage waveforms and operation for driving panel 10 are described. In the present embodiment, one field is divided into 10 subfields (SF1, SF2, . . . , SF10), and respective subfields have luminance weights of 1, 2, 3, 6, 11, 18, 30, 44, 60, and 81. In the present embodiment, thus, a later subfield is set to have a larger luminance weight. In the present invention, however, the number of subfields and the luminance weight of each subfield are not limited to the above-mentioned values.

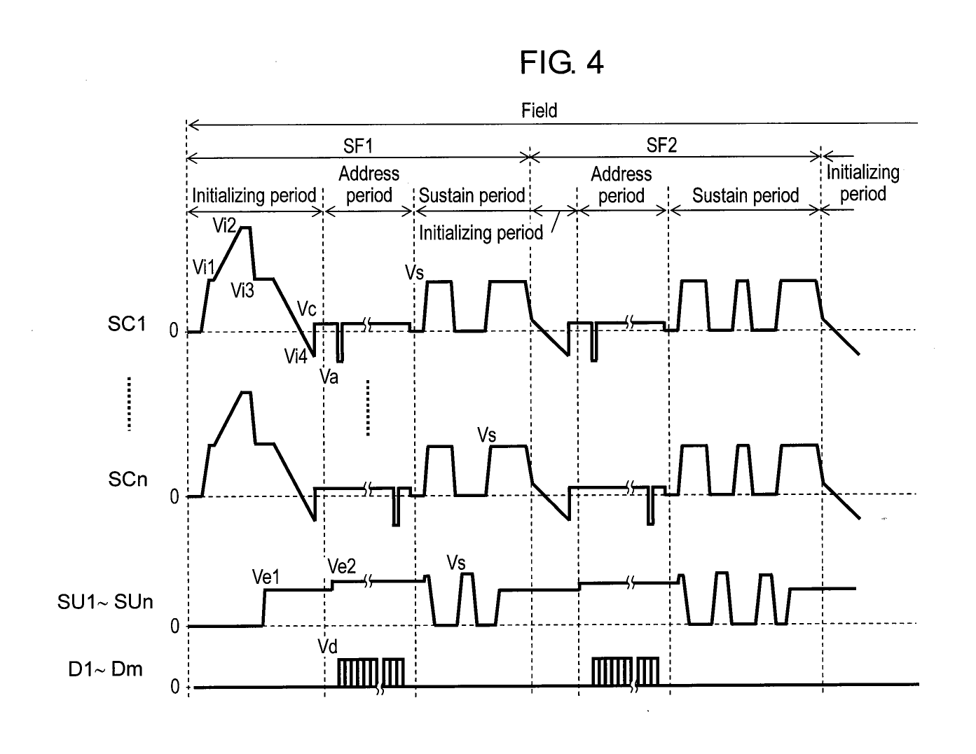

FIG. 4 is a diagram showing a driving voltage waveform of plasma display device 40 in accordance with the first exemplary embodiment of the present invention.

In the initializing period, firstly in the first half thereof, data electrodes D1 through Dm and sustain electrodes SU1 through SUn are kept at 0 (V), and a ramp waveform voltage is applied to scan electrodes SC1 through SCn. Here, the ramp waveform voltage gradually rises from voltage Vi1, which is not higher than a discharge start voltage, to voltage Vi2, which is higher than the discharge start voltage. Then, feeble initializing discharge occurs in all discharge cells, and wall voltage is accumulated on scan electrodes SC1 through SCn, sustain electrodes SU1 through SUn, and data electrodes D1 through Dm. Here, the wall voltage on the electrodes means the voltage generated by wall charge accumulated on the dielectric layer for covering the electrodes and on the phosphor layers.

In the subsequent latter half of the initializing period, sustain electrodes SU1 through SUn are kept at positive voltage Ve1, and a ramp waveform voltage which gradually falls from voltage V13 to voltage V14 is applied to scan electrodes SC1 through SCn. At this time, feeble initializing discharge occurs again in all discharge cells, and the wall voltage on scan electrodes SC1 through SCn, sustain electrodes SU1 through SUn, and data electrodes D1 through Dm is adjusted to a value appropriate for address operation.

The first half of the initializing period may be omitted in some subfields of all subfields constituting one field. In that case, initializing operation is selectively performed in the discharge cell having undergone sustain discharge in the immediately preceding subfield. FIG. 4 shows a driving voltage waveform where initializing operation having a first half and latter half is performed in the initializing period of SF1, and initializing operation having only latter half is performed in the initializing period of SF2 and later.

In the address period, sustain electrodes SU1 through SUn are kept at voltage Ve2, and voltage Vc is applied to scan electrodes SC1 through SCn. Then, based on the image data of each color, an address pulse of voltage Vd is applied to data electrode Dk (k is 1 through m) of the discharge cell to emit light in the first row, of data electrodes D1 through Dm, and a scan pulse of voltage Va is applied to scan electrodes SC1 of the first row. At this time, address discharge occurs between data electrode Dk and scan electrode SC1 and between sustain electrode SU1 and scan electrode SC1, positive wall voltage is accumulated on scan electrode SC1 of this discharge cell, and negative wall voltage is accumulated on sustain electrode SU1. Thus, the address operation is performed where address discharge is caused in the discharge cell to emit light in the first row to accumulate wall voltage on each electrode. While, address discharge does not occur in the intersecting part of scan electrode SC1 and data electrode Dh (h≠k) having undergone no address pulse. This address operation is sequentially performed until the discharge cell of the n-th row, and the address period is completed.

As discussed above, it is data electrode driving circuit 42 that drives each of data electrodes D1 through Dm. When the panel is seen from the side of data electrode driving circuit 42, each data electrode Dj serves as a capacitive load. Therefore, in the address period, whenever the voltage applied to each data electrode Dj is switched from voltage 0 (V) to voltage Vd, or from voltage Vd to voltage 0 (V), this capacitance must be charged and discharged. Increasing the frequency of charge and discharge increases the power consumption of data electrode driving circuit 42.

At this time, each of data drivers 42(1) through 42(16) must not exceed predetermined maximum allowable power EGYmax. In other words, highest value EGY of respective power consumptions of data drivers 42(1) through 42(16) must be the maximum allowable power EGYmax or lower.

In the subsequent sustain period, the voltage of sustain electrodes SU1 through SUn is returned to 0 (V), and a sustain pulse of voltage Vs is applied to scan electrodes SC1 through SCn. At this time, in the discharge cell having undergone the address discharge, the voltage between scan electrode SCi and sustain electrode SUi is obtained by adding the wall voltage on scan electrode SCi and that on sustain electrode SUi to voltage Vs, and exceeds the discharge start voltage. Then, sustain discharge occurs between scan electrode SCi and sustain electrode SUi to emit light. Negative wall voltage is accumulated on scan electrode SCi, and positive wall voltage is accumulated on sustain electrode SUi.

Subsequently, the voltage of scan electrodes SC1 through SCn is returned to 0 (V), and a sustain pulse of voltage Vs is applied to sustain electrodes SU1 through SUn. At this time, in the discharge cell having undergone the sustain discharge, the voltage between sustain electrode SUi and scan electrode SCi exceeds the discharge start voltage. Therefore, sustain discharge occurs again between sustain electrode SUi and scan electrode SCi, negative wall voltage is accumulated on sustain electrode SUi, and positive wall voltage is accumulated on scan electrode SCi. Hereinafter, similarly, as many sustain pulses as the number corresponding to the luminance weight are applied to scan electrodes SC1 through SCn and sustain electrodes SU1 through SUn, thereby continuously performing sustain discharge in the discharge cell where the address discharge occurs in the address period. In the discharge cell where the address discharge does not occur in the address period, the sustain discharge does not occur, and wall voltage at the completion of the initializing period is kept. Thus, the sustain operation in the sustain period is completed.

Also in subsequent SF2 through SF10, operation similar to that in SF1 is performed except for the number of sustain pulses.

In the subfield method, as discussed above, one field period is constituted by a plurality of subfields of a predetermined luminance weight. A plurality of combinations is selected from arbitrary combinations of the subfields, and a combination set for display is created. Using a combination of the subfields belonging to the combination set for display, the light emission or no light emission in a discharge cell is controlled and gradation is displayed. Hereinafter, the combination set for display created by selecting the plurality of combinations of the subfields is referred to as “coding table”. In the present embodiment, a plurality of coding tables of different number of combinations is provided for the image signals of respective colors. These image signals are red image signal sigR (sometimes simply referred to as “sigR”), green image signal sigG (sometimes simply referred to as “sigG”), and blue image signal sigB (sometimes simply referred to as “sigB”). A used coding table is selected according to the signal level of the image signal of each color.

Next, the combination set for display used in the present embodiment, namely the coding table, is described. In order to simplify the description, the gradation when black is displayed is denoted with “0” and the gradation corresponding to luminance weight “N” is denoted with “N” for each of red image signal sigR, green image signal sigG, and blue image signal sigB. Therefore, the gradation of a discharge cell undergoing light emission only in SF1 having luminance weight “1” is “1”, and the gradation of a discharge cell undergoing light emission both in SF1 having luminance weight “1” and in SF2 having luminance weight “2” is “3”.

In the present embodiment, a coding table used for the image signal of each color is selected from two coding tables.

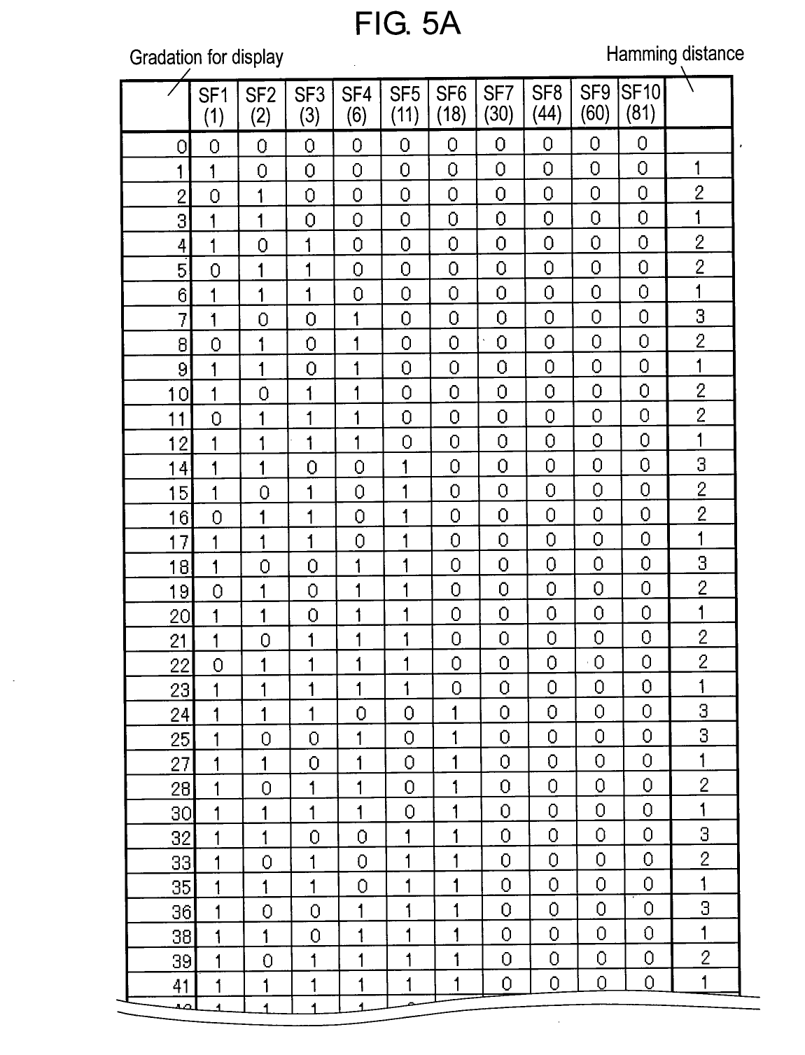

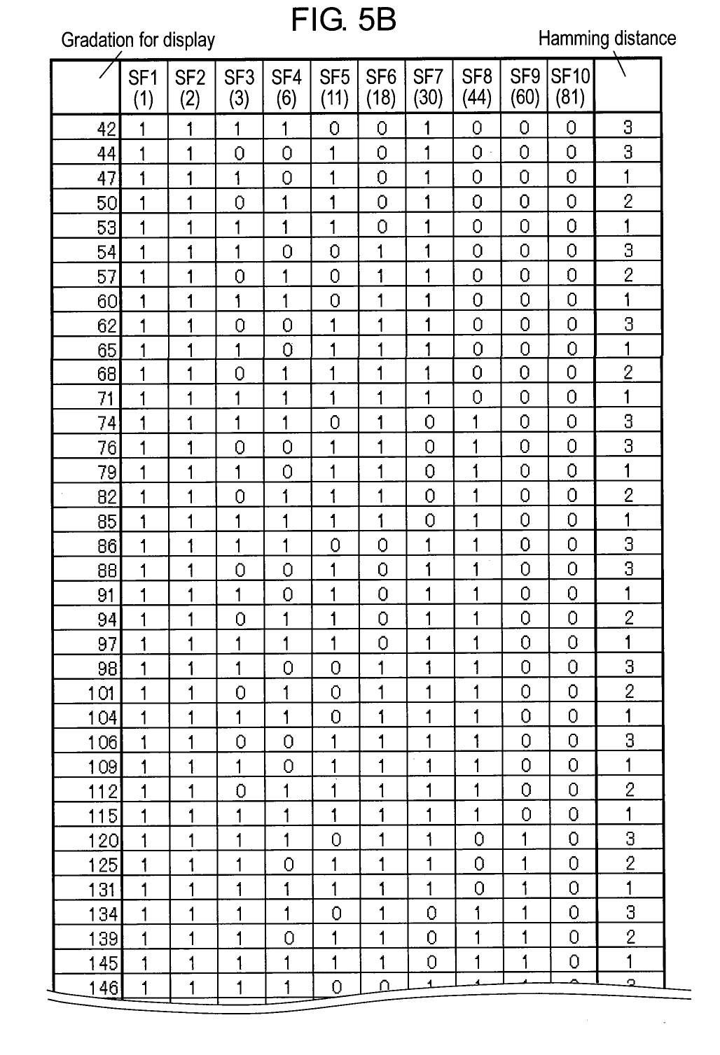

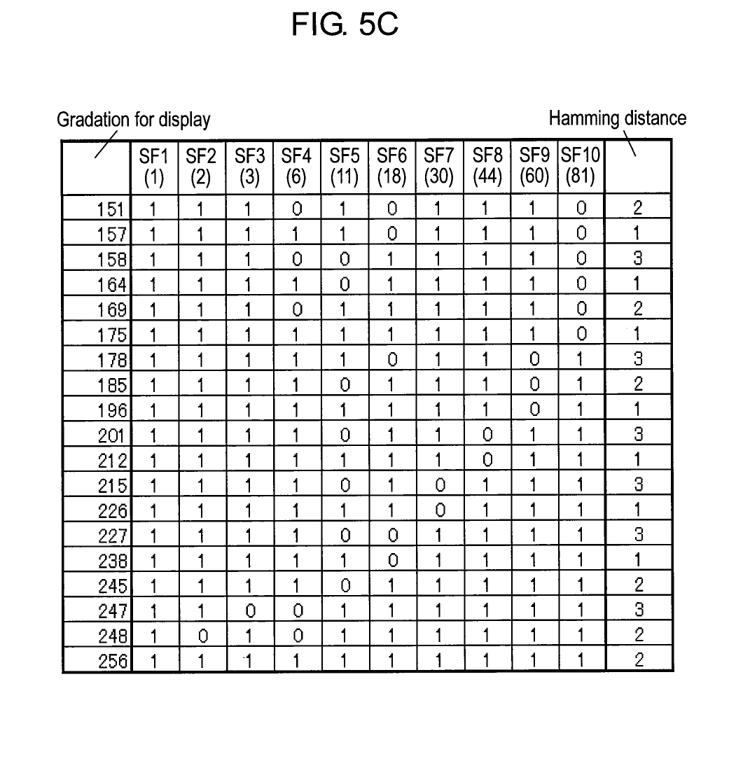

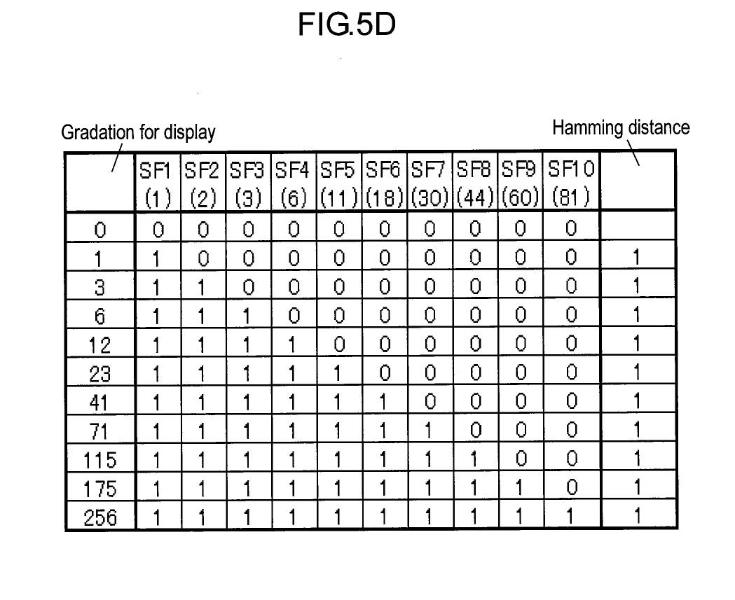

FIG. 5A, FIG. 5B, FIG. 5C, and FIG. 5D are diagrams showing coding tables used in plasma display device 40 of the first exemplary embodiment of the present invention. FIG. 5A, FIG. 5B, and FIG. 5C are diagrams showing the first coding table having 90 combinations of the subfields. FIG. 5D is a diagram showing the second coding table having 11 combinations of the subfields. In the present embodiment, one of the two coding tables is selected as each coding table used for the image signal of each color based on the signal level of the image signal of each color and the power consumption of the data electrode driving circuit.

In FIG. 5A, FIG. 5B, FIG. 5C, and FIG. 5D, the numerical values in the leftmost column show gradations for display used for display. The right side thereof shows whether to emit light in a discharge cell in each subfield when each gradation is displayed, and “0” shows no light emission and “1” shows light emission. For example, in FIG. 5A, light is emitted in the discharge cell only in SF2 in order to display gradation “2”, and light is emitted in the discharge cell in SF1, SF2, and SF5 in order to display gradation “14”. In order to display gradation “3”, there are a method of emitting light in the discharge cell in SF1 and SF2 and a method of emitting light only in SF3. When a plurality of combinations is thus allowed, the combination where light is emitted in subfields of minimum luminance weights is selected. In other words, when gradation “3” is displayed, light is emitted in the discharge cell in SF1 and SF2.

Image signal processing circuit 41 converts the image signal of each color (red image signal sigR, green image signal sigG, or blue image signal sigB) into image data of each color (red image data dataR, green image data dataG, or blue image data dataB). In the image data of each color, the light emission and no light emission in the discharge cell in each subfield correspond to bits “1” and “0” of the digital signal. Therefore, image data “0000000000” showing gradation “0” indicates no light emission in SF1 through SF10, image data “1000000000” showing gradation “1” indicates light emission only in SF1, image data “0100000000” showing gradation “2” indicates light emission only in SF2, and image data “1100000000” showing gradation “3” indicates light emission in SF1 and SF2.

The number of bits different from each other when corresponding bits between two pieces of image data are compared with each other is called hamming distance. For example, the hamming distance between the image data of gradation “0” and the image data of gradation “1” is “1” because corresponding bits in SF1 are not equal to each other. The hamming distance between the image data of gradation “0” and the image data of gradation “3” is “2” because corresponding bits in SF1 and SF2 are not equal to each other. The right columns of FIG. 5A, FIG. 5B, FIG. 5C, and FIG. 5D show the hamming distances between certain gradations for display and the next smaller gradations for display. Here, the next smaller gradation for display is the highest within the range smaller than the certain gradation for display. For example, the right column of gradation for display “247” shows hamming distance “3” between gradation for display “247” and the next smaller gradation for display “245”.

In the first coding table, the hamming distances between adjacent gradations for display are large, their values are “1”, “2”, or “3”, and the average value of them is “1.91”. In the second coding table, the hamming distances are the smallest, their values are “1”, and the average value of them is also “1.00”. In the first coding table and second coding table of the present embodiment, thus, the average value of the hamming distances between certain gradations and the next smaller gradations in the coding table having a small number of combinations is smaller than that in the coding table having a large number of combinations.

When the coding table having the large number of combinations of the subfields is used for displaying an image, the number of displayable gradations increases and hence the representing performance of the image can be improved. When the hamming distances increase, however, switching frequency of the voltage applied to each data electrode Dj from voltage 0 (V) to voltage Vd or from voltage Vd to voltage 0 (V) rises in the address period, and the power consumption of data electrode driving circuit 42 increases.

Therefore, when the coding table having the large number of combinations of the subfields is used, the number of displayable gradations increases and hence the representing performance of the image improves, but the hamming distances between adjacent gradations for display increase to increase the power consumption. When the coding table having the small number of combinations of the subfields is used, the number of displayable gradations decreases and hence the representing performance of the image degrades. However, in the latter case, the hamming distances between adjacent gradations for display decrease to suppress the power consumption.

Therefore, regarding an image signal where the image display quality does not reduce even if the number of displayable gradations is small, using the coding table having the small number of combinations of the subfields for the image signal can suppress the power consumption of data electrode driving circuit 42. In the present embodiment, the signal levels of image signals of respective colors are compared with each other, and the coding table having the large number of displayable gradations is used for the image signal of the color having a relatively large signal level, thereby securing the image display quality. For the image signal of the color that has a relatively low signal level, the image display quality does not significantly reduce even if the number of displayable gradations is small, and hence the coding table having the small number of combinations of the subfields is used to suppress the power consumption.

Thus, respective signal levels of red image signal sigR, green image signal sigG, and blue image signal sigB are compared with each other. For the image signal of a color that has a relatively low signal level, the following combination set for display is used. In this combination set, the number of combinations is smaller than that in the combination set for display used for the image signal of a color that has a relatively high signal level. Thus, the electric power is reduced without sacrificing the image display quality.

In the present embodiment, each coding table used for the image signal of each color is determined based on not only the signal level of the image signal of each color but also the power consumption of data electrode driving circuit 42.

Specifically, attention is firstly focused on red image signal sigR. The signal level of red image signal sigR is compared with the signal level of green image signal sigG. For red image signal sigR where the ratio of the signal level to that of green image signal sigG is smaller than predetermined constant Kr, the following combination set for display is used. In this combination set, the number of combinations is smaller than that in the combination set for display used for red image signal sigR where the ratio of the signal level to that of green image signal sigG is predetermined constant Kr or larger.

In other words, red image signal sigR is compared with green image signal sigG. The first coding table is used for red image signal sigR in a region satisfying

sigG×Kr≦sigR. (condition R1)

The second coding table is used for red image signal sigR in a region satisfying

sigR<sigG×Kr. (condition R2)

Here, constant Kr is set based on highest value EGY of the power consumptions of data drivers 42(1) through 42(16).

Attention is then focused on green image signal sigG. The signal level of green image signal sigG is compared with that of red image signal sigR and that of blue image signal sigB. For green image signal sigG where the ratio of the signal level to the higher one of the signal levels of red image signal sigR and blue image signal sigB is smaller than predetermined constant Kg, the following combination set for display is used. In this combination set, the number of combinations is smaller than that in the combination set for display used for green image signal sigG where the ratio of the signal level to the higher one of the signal levels of red image signal sigR and blue image signal sigB is predetermined constant Kg or larger.

In other words, red image signal sigR, green image signal sigG, and blue image signal sigB are compared with each other. The first coding table is used for green image signal sigG in a region satisfying

max(sigR,sigB)×Kg≦sigG. (condition G1)

Here, max(A, B) means selection of the higher one of numerical values A and B.

The second coding table is used for green image signal sigG in a region satisfying

sigG<max(sigR,sigB)×Kg. (condition G2)

Here, constant Kg is set based on highest value EGY of the power consumptions of data drivers 42(1) through 42(16).

Attention is then focused on blue image signal sigB. The signal level of blue image signal sigB is compared with that of green image signal sigG. For blue image signal sigB where the ratio of the signal level to that of green image signal sigG is smaller than predetermined constant Kb, the following combination set for display is used. In this combination set, the number of combinations is smaller than that in the combination set for display used for blue image signal sigB where the ratio of the signal level to that of green image signal sigG is predetermined constant Kb or larger.

In other words, blue image signal sigB is compared with green image signal sigG. The first coding table is used for blue image signal sigB in a region satisfying

sigG×Kb≦sigB. (condition B1)

The second coding table is used for blue image signal sigB in a region satisfying

sigB<sigG×Kb. (condition B2)

Here, constant Kb is set based on highest value EGY of the power consumptions of data drivers 42(1) through 42(16).

When the signal levels of the image signals of respective colors are equal to each other, the green light emission has the highest luminance comparing with the red light emission and blue light emission, the visual sensitivity to the gradation is also the highest. In the present embodiment, in consideration of the above-mentioned discussion, a coding table used for red image signal sigR is selected by comparing red image signal sigR with green image signal sigG, and a coding table used for blue image signal sigB is selected by comparing blue image signal sigB with green image signal sigG.

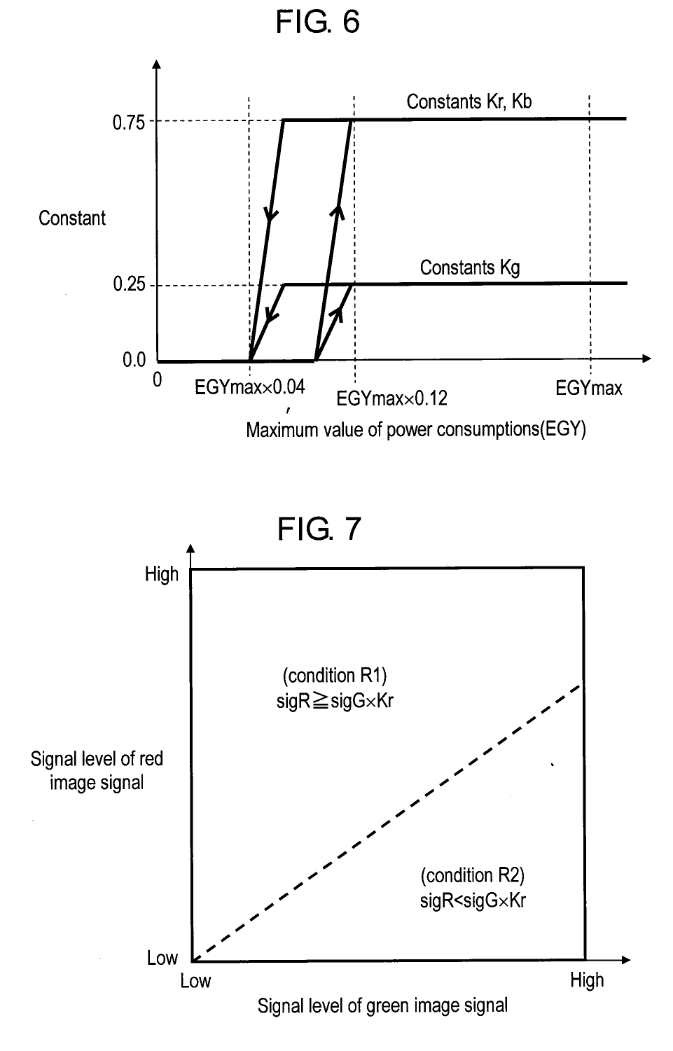

FIG. 6 is a diagram showing a relationship between constants Kr, Kg, and Kb and highest value EGY of the power consumptions of data drivers 42(1) through 42(16) in the plasma display device 40 in accordance with a first exemplary embodiment of the present invention. The horizontal axis shows highest value EGY of the power consumptions, and the vertical axis shows the values of predetermined constants Kr, Kg, and Kb. When highest value EGY of the power consumptions is 0.12 or larger times maximum allowable power EGYmax, constant Kr and constant Kb are set to “0.75” and constant Kg is set to “0.25”. When highest value EGY of the power consumptions is lower than 0.04 times maximum allowable power EGYmax, constant Kr and constant Kb are set to “0” and constant Kg is set to “0”. When highest value EGY of the power consumptions is 0.04 to 0.12 times maximum allowable power EGYmax, each constant is set to a value equal to each of the above-mentioned values or to a value between them.

At this time, as shown in FIG. 6, in a range where each constant varies, a hysteresis characteristic may be provided by the following method: the value of each constant when highest value EGY of the power consumptions varies in the decreasing direction is set to a value larger than the value of each constant when highest value EGY of the power consumptions varies in the increasing direction. In the present embodiment, when highest value EGY of the power consumptions varies in the decreasing direction, the values of constants Kr, Kg, and Kb are set to be fixed until highest value EGY of the power consumptions becomes smaller than 0.12 times maximum allowable power EGYmax, and the values of constants Kr, Kg, and Kb are reduced when highest value EGY further reduces. When highest value EGY of the power consumptions varies in the increasing direction, the values of constants Kr, Kg, and Kb are set to be fixed until highest value EGY of the power consumptions becomes larger than 0.04 times maximum allowable power EGYmax. When highest value EGY further increases, the values of constants Kr, Kg, and Kb are increased. This setting can reduce the varying frequency of each constant with respect to the variation of the image signal, so that the possibility of causing flicker or the like in response to variation of each constant is prevented.

FIG. 7 is a schematic diagram showing the selective use of the coding tables of plasma display device 40 in accordance with the first exemplary embodiment of the present invention. FIG. 7 shows the selective use of the coding tables when highest value EGY of the power consumptions is 0.12 or larger times maximum allowable power EGYmax. The vertical axis shows the signal level of red image signal sigR, and the horizontal axis shows the signal level of green image signal sigG. To make the diagram easy-to-understand, the signal level of blue image signal sigB is assumed to be “0”.

Regarding an image signal satisfying (condition R1) in FIG. 7, the signal level of red image signal sigR is higher than that of green image signal sigG, and hence the first coding table is used for red image signal sigR. Regarding an image signal satisfying (condition R2), the signal level of red image signal sigR is lower than that of green image signal sigG, and hence the second coding table is used for red image signal sigR.

In the present embodiment, the second coding table is thus used for an image signal where relative signal level is low and the display quality of the image does not reduce even when the number of displayable gradations decreases, among the image signals of respective colors. Thus, the electric power is reduced without sacrificing the image display quality.

Constants Kr, Kg, and Kb shown in FIG. 6 are set based on highest value EGY of the power consumptions of data drivers 42(1) through 42(16). Thus, when the power consumption of data electrode driving circuit 42 is large, the value of each constant is set to be large, the application range of an image signal employing the coding table having a small number of combinations of the subfields is enlarged, and suppression of the power consumption is prioritized during driving. When the power consumption of data electrode driving circuit 42 is small, the value of each constant is set to be small, the number of displayable gradations increases, and image display performance is prioritized during driving.

In other words, when the power consumption of data electrode driving circuit 42 is large, a combination set for display is used where the number of combinations is smaller than that in the combination set for display used for an image signal when the power consumption of data electrode driving circuit 42 is small.

Next, the configuration of image signal processing circuit 41 for switching the coding tables based on the image signal and the power consumptions of data drivers 42(1) through 42(16) is described.

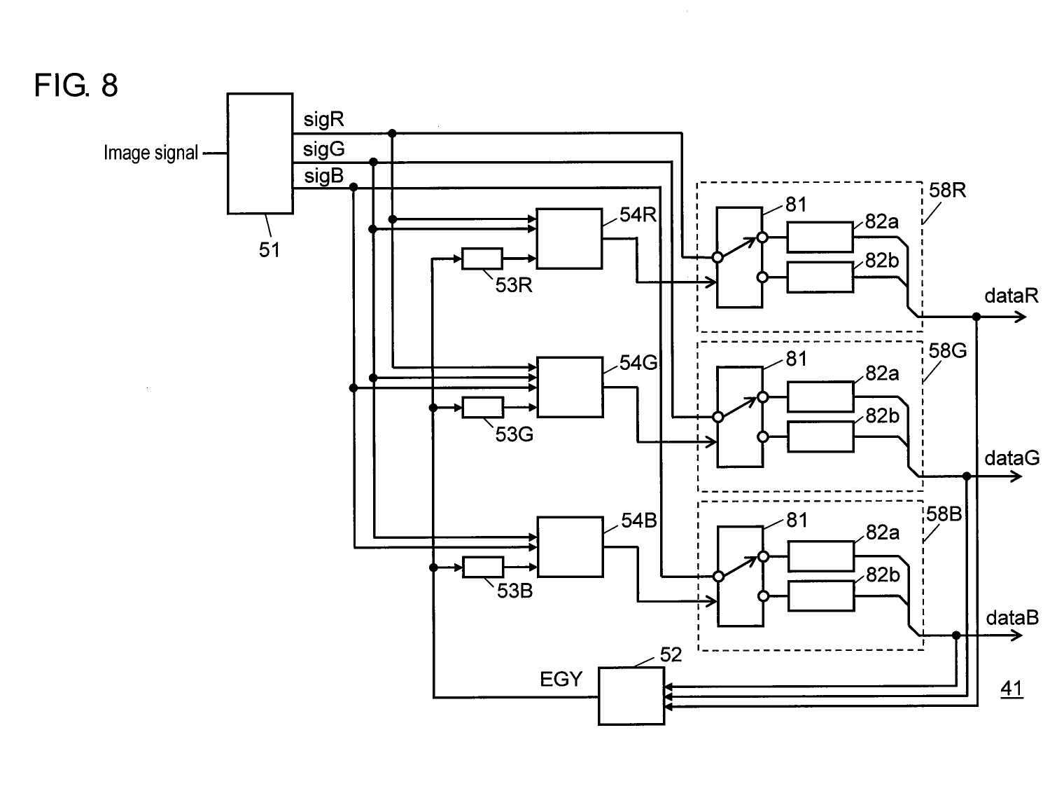

FIG. 8 is a circuit block diagram showing the detail of image signal processing circuit 41 of plasma display device 40 in accordance with the first exemplary embodiment of the present invention. Image signal processing circuit 41 has color separating section 51, power predicting section 52, Kr setting section 53R, Kg setting section 53G, Kb setting section 53B, R comparing section 54R, G comparing section 54G, B comparing section 54B, R data converting section 58R, G data converting section 58G, and B data converting section 58B.

Color separating section 51 separates an input image signal such as a National Television Standards Committee (NTSC) image signal into three primary colors, namely red image signal sigR, green image signal sigG, and blue image signal sigB. When image signals of respective colors are input as input image signals, color separating section 51 may be omitted.

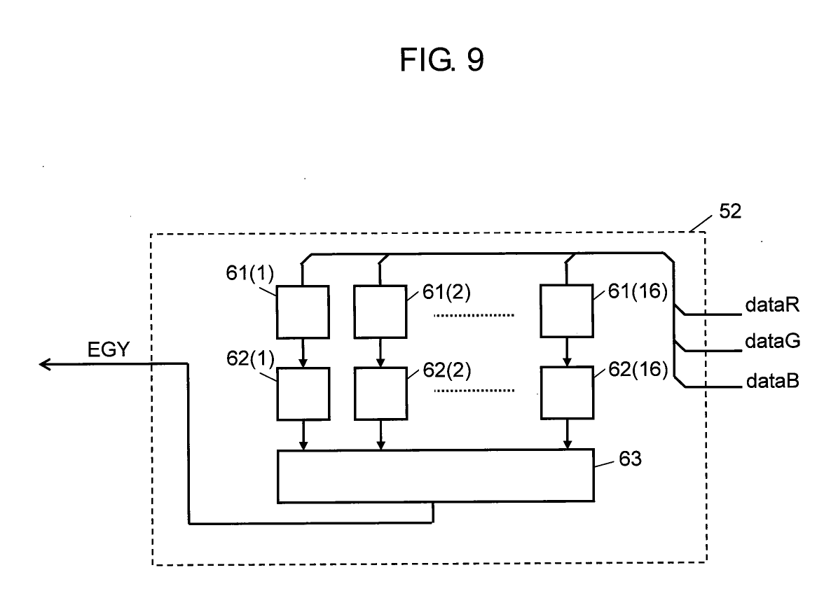

Power predicting section 52 calculates predicted values of the power consumptions of data drivers 42(1) through 42(16), and outputs highest value EGY of them. FIG. 9 is a circuit block diagram of power predicting section 52 in accordance with the first exemplary embodiment of the present invention. Power predicting section 52 has the following elements:

driver power calculating sections 61(1) through 61(16) for calculating respective power consumptions of data drivers 42(1) through 42(16);

driver power accumulating sections 62(1) through 62(16) for accumulating respective outputs from driver power calculating sections 61(1) through 61(16) for a predetermined time; and

maximum value selecting section 63 for selecting the largest value of the outputs from driver power accumulating sections 62(1) through 62(16).

The electric power of data electrode driving circuit 42 increases as the changing frequency of the voltage applied to each data electrode Dj increases, as discussed above. When the voltages applied to adjacent data electrode Dj+1 and Dj−1 in opposite phases, the electric power increases further. Thanks to such a relation, for example, when the summation of exclusive OR of vertical and lateral pixels is performed with respect to each bit of image data corresponding to each subfield, electric power required for driving data electrodes D1 through Dm can be estimated. Driver power calculating sections 61(1) through 61(16) of the present embodiment calculate electric powers of data drivers 42(1) through 42(16) in such a method. Driver power accumulating sections 62(1) through 62(16) are disposed in order to find a correlation to the temperature increase of data drivers 42(1) through 42(16), but may be omitted. In this configuration, power predicting section 52 calculates estimated values of respective power consumptions of data drivers 42(1) through 42(16), and outputs highest value EGY of them.

Kr setting section 53R outputs constant Kr shown in FIG. 6 based on highest value EGY of the power consumptions. R comparing section 54R compares constant Kr times green image signal sigG with red image signal sigR using constant Kr. A signal indicating which of (condition R1) and (condition R2) is satisfied is output as the comparison result to R data converting section 58R.

Kg setting section 53G and G comparing section 54G, and Kb setting section 53B and B comparing section 54B are operated similarly to Kr setting section 53R and R comparing section 54R, respectively.

R data converting section 58R has coding selecting section 81 and two coding tables 82a and 82b, and converts red image signal sigR into red image data dataR. Here, red image data dataR is a combination of subfields for controlling light emission or no light emission of a red discharge cell.

Coding selecting section 81 selects one of two coding tables 82a and 82b based on the comparison result of R comparing section 54R. Specifically, coding selecting section 81 selects first coding table 82a in a region satisfying (condition R1), and selects second coding table 82b in a region satisfying (condition R2). Each of coding tables 82a and 82b is constituted by a data converting table in a read only memory (ROM) or the like, and converts input red image signal sigR into red image data dataR. Coding table 82a is the first coding table shown in FIG. 5A, FIG. 5B, and FIG. 5C. Coding table 82b is the second coding table shown in FIG. 5D.

G data converting section 58G and B data converting section 58B have a configuration similar to that of R data converting section 58R.

Such a configuration can provide a panel driving method capable of reducing electric power without sacrificing the image display quality, and a plasma display device using the driving method.

In the present embodiment, as each coding table used for the image signal of each color, one coding table is selected and used from two coding tables based on the relative comparison between signal levels of the image signals of respective colors and the power consumptions of the data drivers. However, the present invention is not limited to this. For example, three or more coding tables may be disposed for the image signal of each color, and one coding table may be selected and used from three or more coding tables based on the signal level of the image signal of each color and the power consumptions of the data drivers. The coding tables may be selectively used in consideration of not only the signal level of the image signal of each color but also another attribute such as motion of the image. A circuit for displaying gradation that is not included in the gradations for display may be added. One example thereof is hereinafter described as a second exemplary embodiment.

### Second Exemplary Embodiment

The structure of the panel and the driving voltage waveforms applied to the electrodes are the same as those of the first exemplary embodiment, so that descriptions of them are omitted. In the second exemplary embodiment, each coding table used for the image signal of each color is selected and used from four coding tables. Each coding table used for an image signal of each color is selected based on relative signal level of the image signal of each color, absolute signal level of the image signal, spatial difference of the image signal of each color, time difference of the image signal of each color, and the power consumptions of data drivers 42(1) through 42(16).

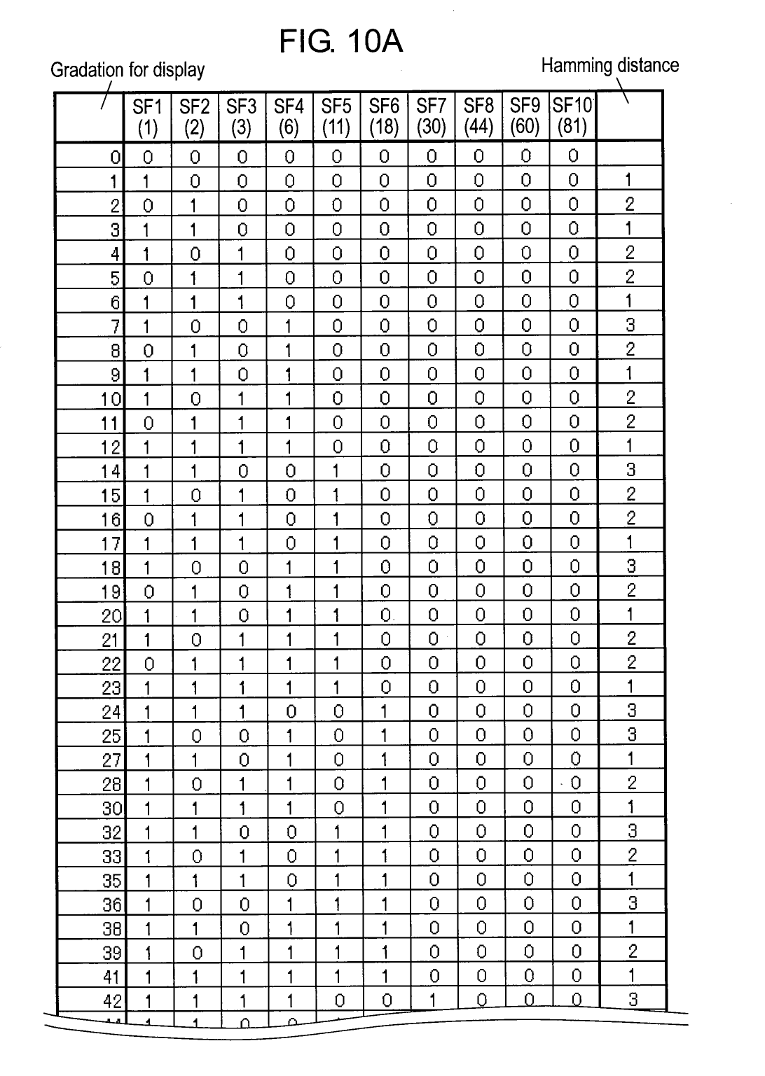

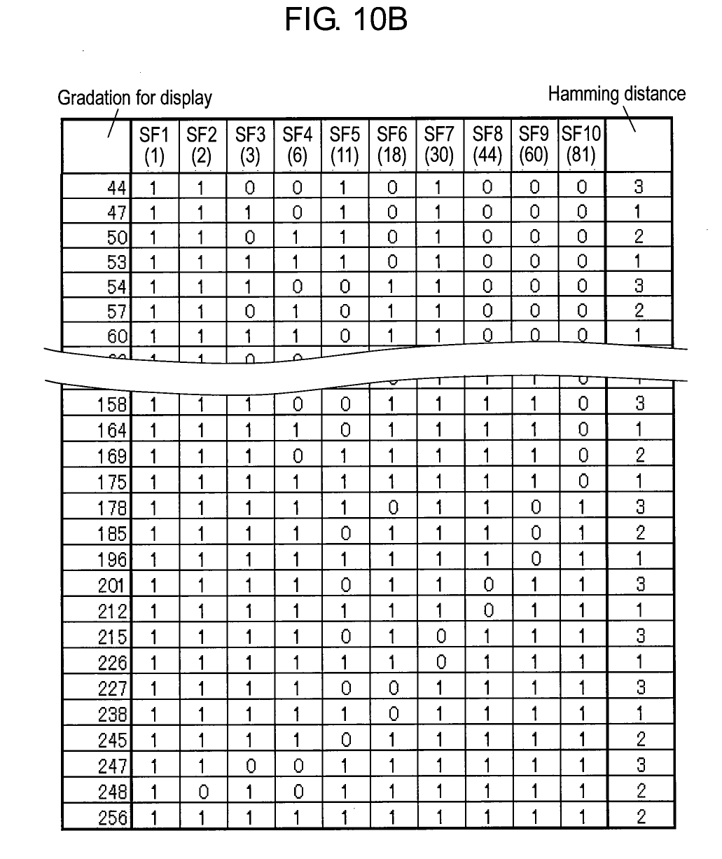

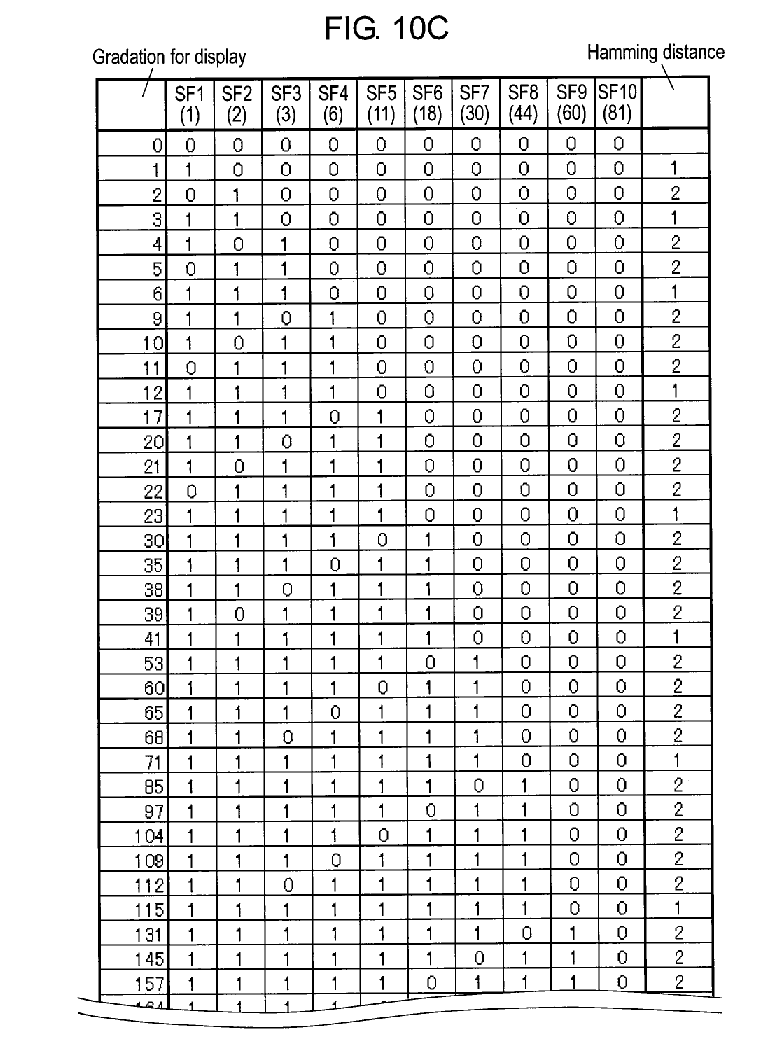

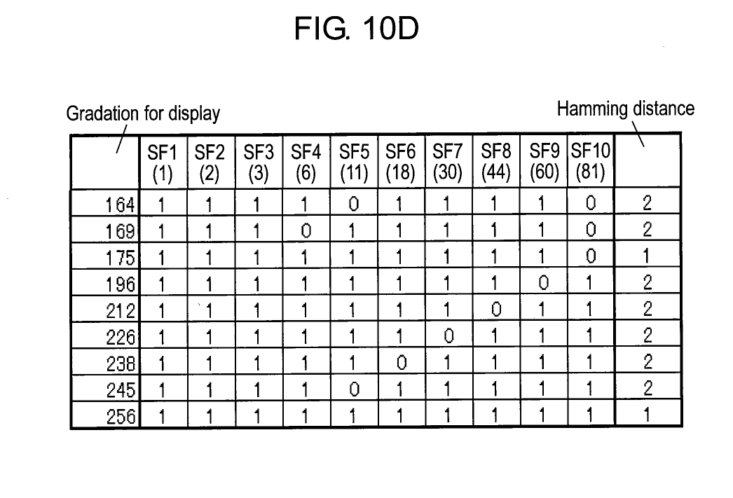

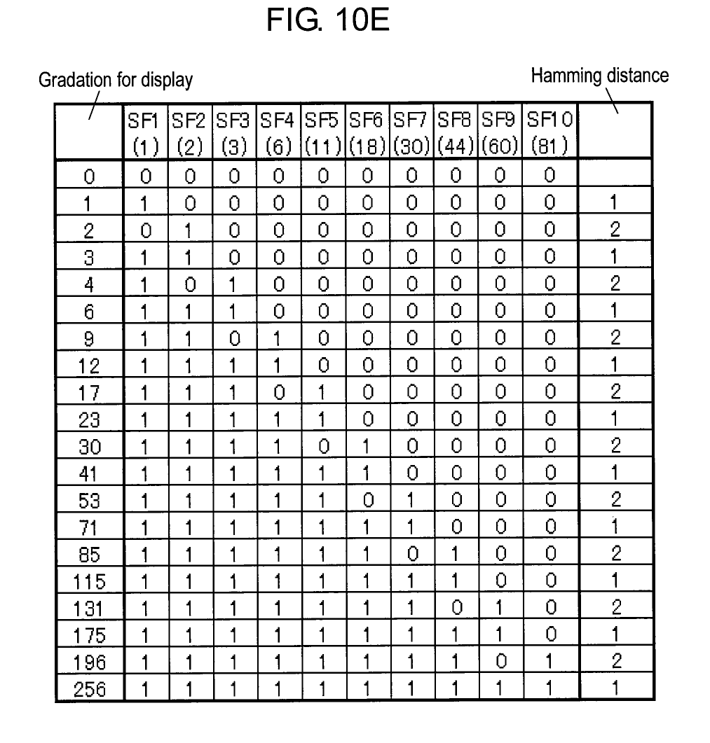

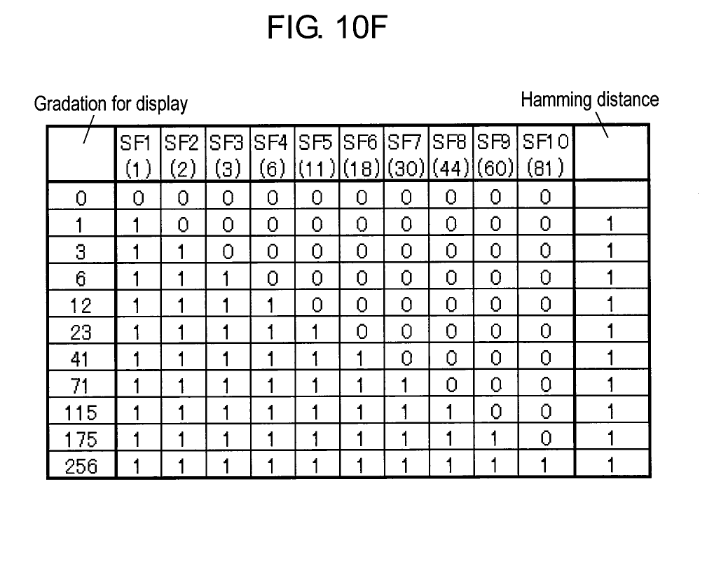

FIG. 10A, FIG. 10B, FIG. 10C, FIG. 10D, FIG. 10E, and FIG. 10F are diagrams showing coding tables used in plasma display device 40 in accordance with the second exemplary embodiment of the present invention. FIG. 10A and FIG. 10B show a first coding table having 90 combinations of subfields, and this coding table is the same as the first coding table shown in FIG. 5A, FIG. 5B, and FIG. 5C. FIG. 10C and FIG. 10D show a second coding table having 44 combinations of subfields, and FIG. 10E shows a third coding table having 20 combinations of subfields. FIG. 10F shows a fourth coding table having 11 combinations of subfields, and this coding table is the same as the second coding table shown in FIG. 5D.

In the first coding table, the hamming distances between adjacent gradations for display are the largest, their values are “1”, “2”, or “3”, and the average value of them is “1.91”. In the second coding table, the hamming distances are “1” or “2”, “2” appears more frequently, and the average value of them is “1.77”. In the third coding table, the hamming distances are “1” or “2”, the appearing frequency of “2” is substantially the same as that of “1”, and the average value of them is “1.47”. In the fourth coding table, the hamming distances are the smallest, their values are “1”, and the average value of them is also “1.00”. Also in the present embodiment, the average value of the hamming distances between certain gradations and the next smaller gradations in the coding table that has a small number of combinations is set to be smaller than that in the coding table that has a large number of combinations.

As discussed above, when a coding table having a large number of combinations of the subfields is used, the number of displayable gradations increases and hence the representing performance of the image improves, but the hamming distances between adjacent gradations for display increase to increase the power consumption. In addition, a false contour is apt to occur. When the coding table having a small number of combinations of the subfields is used, the number of displayable gradations decreases and hence the representing performance of the image degrades. However, in the latter case, the hamming distances between adjacent gradations for display decrease to suppress the power consumption. In addition, a false contour hardly occurs.

Therefore, regarding an image signal whose image display quality does not degrade even when the number of displayable gradations is small, using a coding table having a small number of combinations of the subfields for this image signal can suppress the power consumption of data electrode driving circuit 42. In the present embodiment, each coding table used for the image signal of each color is determined based on the degree of the visual sensitivity to the gradation and the electric powers of data drivers 42(1) through 42(16). The degree of the visual sensitivity to the gradation can be determined based on absolute signal level of the image signal of each color, relative signal level of the image signal of each color, level of spatial difference of the image signal, and level of time difference of the image signal. Absolute signal level of the image signal of each color, relative signal level, degree of spatial difference of the image signal, and degree of time difference of the image signal are hereinafter, sequentially described.

Absolute signal level of the image signal is firstly described. Regarding absolute signal level of the image signal, dark image or bright image is determined as follows.

Each of red image signal sigR, green image signal sigG, and blue image signal sigB is multiplied by a coefficient proportional to the luminance, thereby determining luminance conversion signal sigY using

sigY=0.2×sigR+0.7×sigG+0.1×sigB.

Luminance conversion signal sigY is compared with constant BRT, and dark image is determined when the following condition is satisfied:

sigY<BRT.

Bright image is determined when the following condition is satisfied:

sigY≧BRT.

Here, constant BRT is a predetermined constant, and BRT=“16” in the present embodiment.

Next, relative signal level of the image signal of each color is described. As relative signal level of the image signal, high signal level, intermediate signal level, or low signal level is determined as follows.

Attention is firstly focused on red image signal sigR. Red image signal sigR is compared with green image signal sigG. High signal level is determined when the following condition is satisfied:

sigG×Kr1≦sigR.

Intermediate signal level is determined when the following condition is satisfied:

sigG×Kr2≦sigR<sigG×Kr1.

Low signal level is determined when the following condition is satisfied:

sigR<sigG×Kr2.

Here, constants Kr1 and Kr2 are set based on highest value EGY of the power consumptions of the data drivers.

Attention is then focused on green image signal sigG. Red image signal sigR, green image signal sigG, and blue image signal sigB are compared with each other. High signal level is determined when the following condition is satisfied:

max(sigR,sigB)×Kg1≦sigG.

Intermediate signal level is determined when the following condition is satisfied:

max(sigR,sigB)×Kg2≦sigG<max(sigR,sigB)×Kg1.

Low signal level is determined when the following condition is satisfied:

sigG<max(sigR,sigB)×Kg2.

Here, constants Kg1 and Kg2 are set based on highest value EGY of the power consumptions of the data drivers.

Attention is then focused on blue image signal sigB. Blue image signal sigB is compared with green image signal sigG. High signal level is determined when the following condition is satisfied:

sigG×Kb1≦sigB.

Intermediate signal level is determined when the following condition is satisfied:

sigG×Kb2≦sigB<sigG×Kb1.

Low signal level is determined when the following condition is satisfied:

sigB<sigG×Kb2.

Here, constants Kb1 and Kb2 are set based on highest value EGY of the power consumptions of the data drivers.

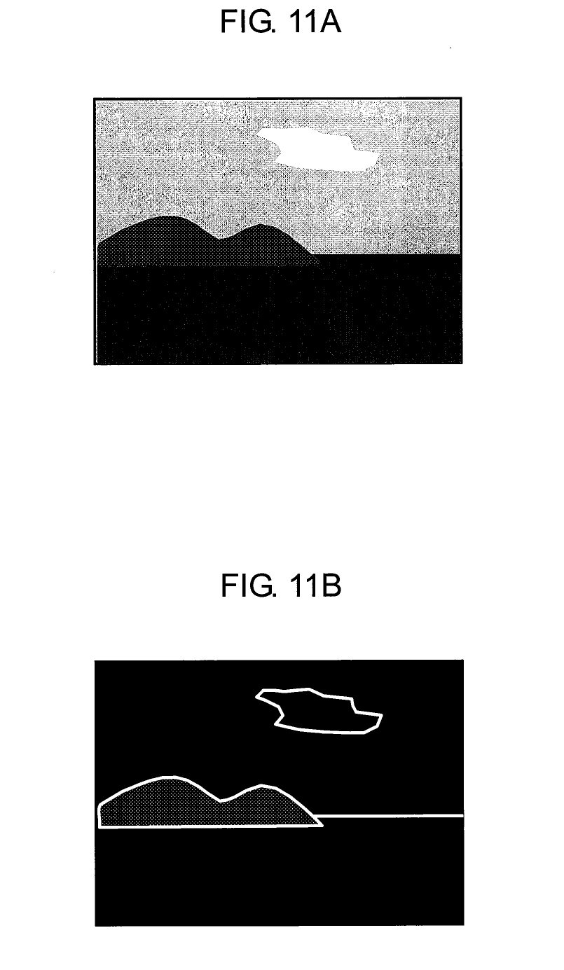

Next, degree of spatial difference of the image signal of each color is described. In a region where variation in gradation is large in a display image, the image display quality hardly reduces even when the number of displayable gradations is small. Therefore, spatial difference of the image signal is calculated, and a coding table having a small number of combinations of the subfields can be used for an image signal of large spatial difference. FIG. 11A and FIG. 11B are diagrams showing an example of a display image of plasma display device 40 in accordance with the second exemplary embodiment of the present invention, and the differential signals of this display image. FIG. 11A shows the example of the display image, and FIG. 11B shows the differential image. In the region where white is displayed in FIG. 11B, the signal levels of the differential signals are large, therefore a coding table having a small number of combinations of the subfields can be used. In the region where black is displayed, the signal levels of the differential signals are low, and a coding table having a large number of combinations of the subfields is preferably used for an image signal in this region in order to prevent the degradation of the image display quality.

Specifically, the spatial difference of the image signal is firstly calculated. In a calculating method of the spatial difference, for red image signal sigR(x, y) at position (x, y) of a pixel on a display screen for example, the following red differential signal may be calculated as the spatial difference:

difR(x,y)=[{sigR(x−1,y)−sigR(x+1,y)}²+{sigR(x,y−1)−sigR(x,y+1)}²]^{1/2}.

Similarly to this, green differential signal difG and blue differential signal difB are calculated.

In the present embodiment, however, attention is focused on only spatial difference of the vertical direction, spatial difference is determined by calculating

difR(x,y)=|sigR(x,y−1)−sigR(x,y)|.

In this calculating method, the differential component of the horizontal direction is not reflected, but the calculation can be greatly simplified. Similarly to this, green differential signal difG(x, y) and blue differential signal difB(x, y) are calculated.

Next, small spatial difference or large spatial difference is determined based on the calculated red differential signal difR, green differential signal difG, and blue differential signal difB.

Attention is firstly focused on red image signal sigR. Small spatial difference is determined when the following condition is satisfied:

difR(x,y)<sigR(x,y)/Cr.

Large spatial difference is determined when the following condition is satisfied:

difR(x,y)≧sigR(x,y)/Cr.

Here, constant Cr is set based on highest value EGY of the power consumptions of data drivers 42(1) through 42(16).

Attention is then focused on green image signal sigG. Small spatial difference is determined when the following condition is satisfied:

difG(x,y)<sigG(x,y)/Cg.

Large spatial difference is determined when the following condition is satisfied:

difG(x,y)≧sigG(x,y)/Cg.

Here, constant Cg is set based on highest value EGY of the power consumptions of data drivers 42(1) through 42(16).

Attention is then focused on blue image signal sigB. Small spatial difference is determined when the following condition is satisfied:

difB(x,y)<sigB(x,y)/Cb.

Large spatial difference is determined when the following condition is satisfied:

difB(x,y)≧sigB(x,y)/Cb.

Here, constant Cb is set based on highest value EGY of the power consumptions of the data drivers.

Next, degree of time difference of the image signal of each color is described. In a region where a still image or an image slow in motion (hereinafter, collectively referred to as “still image”) is displayed, the visual sensitivity to the gradation is apt to be high. In a region where an image fast in motion (hereinafter referred to as “moving image”) is displayed, the visual sensitivity to the gradation is apt to be low. Therefore, the time difference of the image signal is calculated. In a region where a moving image having large time difference is displayed, a coding table having a small number of combinations of the subfields can be used. In a region where a still image having small time difference is displayed, a coding table having a large number of combinations of the subfields is used preferably.

Regarding the motion of the image signal, the time difference of the image signal is calculated. The following method of calculating the time difference can be employed. For red image signal sigR(x, y, t) at position (x, y) of a pixel on a display screen and at time (t) for example, the absolute value of the difference between it and red image signal sigR(x, y, t−1) of the preceding frame is calculated, and the time difference can be calculated using

movR(x,y,t)=|sigR(x,y,t−1)−sigR(x,y,t)|.

Green differential signal movG(x, y, t) and blue differential signal movB(x, y, t) are calculated similarly.

Next, still image or moving image is determined as follows based on calculated red differential signal movR, green differential signal movG, and blue differential signal movB.

Moving image is determined when one of the following conditions is satisfied:

movR(x,y,t)≧sigR(x,y,t)/Mr, for red image signal sigR;

movG(x,y,t)≧sigG(x,y,t)/Mg, for green image signal sigG; and

movB(x,y,t)≧sigB(x,y,t)/Mb, for blue image signal sigB.

Still image is determined when none of them is satisfied.

Here, constants Mr, Mg, and Mb are predetermined constants, and Mr=Mg=Mb=10 in the present embodiment.

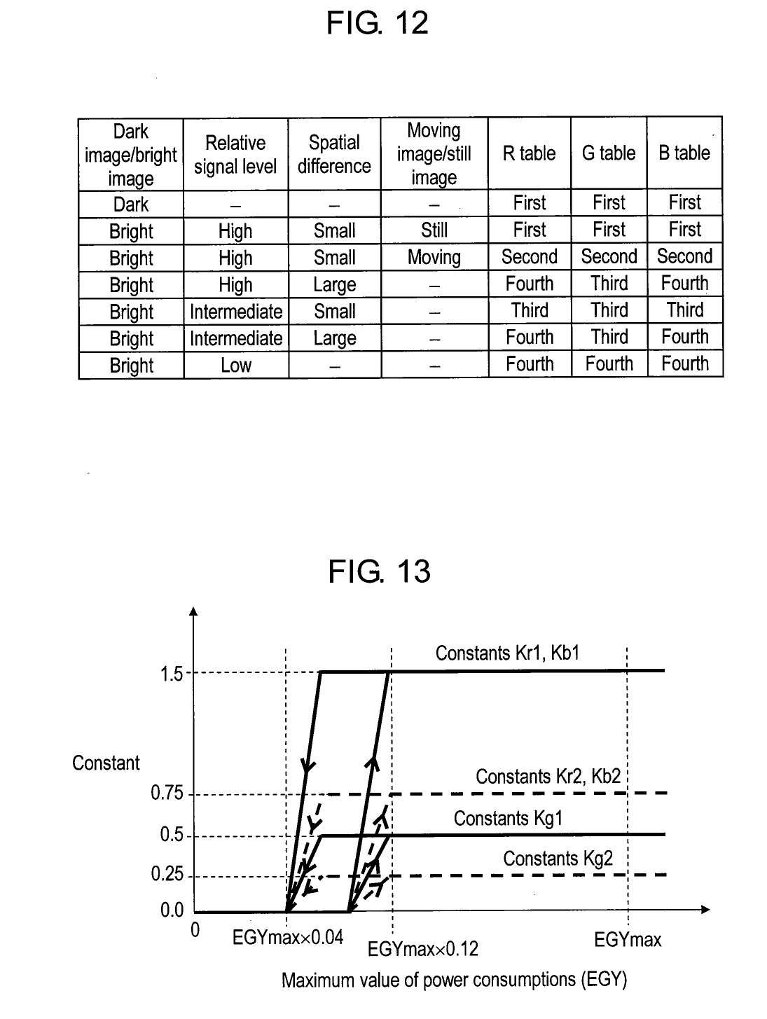

FIG. 12 is a diagram showing the selective use of the coding tables for the image signal of plasma display device 40 in accordance with the second exemplary embodiment of the present invention. Regarding an image signal where luminance conversion signal sigY is low and dark image is determined, the first coding table is used for each of red image signal sigR, green image signal sigG, and blue image signal sigB. Regarding an image signal where luminance conversion signal sigY is high and bright image is determined, the coding tables are used as follows.

Regarding a still image where the relative signal level of the image signal is high and the spatial difference is small, the first coding table is used for each of red image signal sigR, green image signal sigG, and blue image signal sigB. Regarding a moving image where the relative signal level of the image signal is high and the spatial difference is small, the second coding table is used for each of red image signal sigR, green image signal sigG, and blue image signal sigB. The fourth coding table is used for red image signal sigR and blue image signal sigB where the relative signal level is high and the spatial difference is also large, and the third coding table is used for green image signal sigG. The third coding table is used for red image signal sigR, green image signal sigG, and blue image signal sigB where the relative signal level of the image signal is intermediate and the spatial difference is small. The fourth coding table is used for red image signal sigR and blue image signal sigB where the relative signal level of the image signal is intermediate and the spatial difference is large, and the third coding table is used for green image signal sigG. The fourth coding table is used for red image signal sigR, green image signal sigG, and blue image signal sigB where the relative signal level is low.

In a region where the relative signal level of the image signal is low, a coding table is used where the number of combinations is smaller than that in a coding table used in a region where the relative signal level is high. In a region in the display image where the variation in gradation is large, a coding table is used where the number of combinations is smaller than that in a coding table used in a region where the variation in gradation is small. In a region for displaying a moving image, the light emission or no light emission of a discharge cell is controlled using a coding table where the number of combinations is smaller than that in a coding table used in a region for displaying a still image.

In the present embodiment, constants Kr1, Kr2, Kg1, Kg2, Kb1, and Kb2 for determining the height of the signal level of an image signal, and constants Cr, Cg, and Cb for determining the degree of the spatial difference of the image signal are set based on highest value EGY of power consumptions of data drivers 42(1) through 42(16).

FIG. 13 is a diagram showing a relationship between highest value EGY of the power consumptions of the data drivers and constants Kr1, Kg1, Kb1, Kr2, Kg2, and Kb2 in plasma display device 40 in accordance with the second exemplary embodiment of the present invention. The horizontal axis shows highest value EGY of the power consumptions, and the vertical axis shows the respective values of predetermined constants Kr1, Kr2, Kg1, Kg2, Kb1, and Kb2. The solid lines show constants Kr1, Kg1, and Kb1, and the broken lines show constants Kr2, Kg2, and Kb2. When highest value EGY of the power consumptions is 0.12 or larger times maximum allowable power EGYmax, constant Kr1 and constant Kb1 are set to “1.5”, constant Kg1 is set to “0.5”, constants Kr2 and Kb2 are set to “0.75”, and constant Kg2 is set to “0.25”. When highest value EGY of the power consumptions is lower than 0.04 times maximum allowable power EGYmax, constants Kr1, Kg1, Kb1, Kr2, Kg2, and Kb2 are set to “0”. When highest value EGY of the power consumptions is 0.04 to 0.12 times maximum allowable power EGYmax, each constant is set to a value equal to each of the above-mentioned values or to a value between them.

At this time, as shown in FIG. 13, in a range where each constant varies, a hysteresis characteristic may be provided by the following method: the value of each constant when highest value EGY of the power consumptions varies in the decreasing direction is set to a value larger than the value of each constant when highest value EGY of the power consumptions varies in the increasing direction. This setting can reduce the varying frequency of each constant with respect to the variation of the image signal, so that the possibility of causing flicker or the like in response to variation of each constant is prevented.

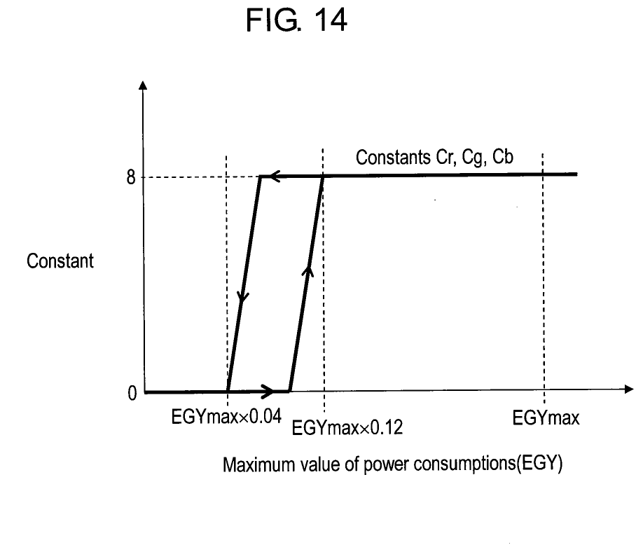

FIG. 14 is a diagram showing a relationship between highest value EGY of the power consumptions of the data drivers and constants Cr, Cg, and Cb in plasma display device 40 in accordance with the second exemplary embodiment of the present invention. The horizontal axis shows highest value EGY of the power consumptions of the data drivers, and the vertical axis shows the values of predetermined constants Cr, Cg, and Cb. When highest value EGY of the power consumptions is 0.12 or larger times maximum allowable power EGYmax, constants Cr, Cg, and Cb are set to “8”. When highest value EGY is lower than 0.04 times maximum allowable power EGYmax, constants Cr, Cg, and Cb are set to “0”. When highest value EGY is 0.04 to 0.12 times maximum allowable power EGYmax, each constant is set to a value equal to each of the above-mentioned values or to a value between them. Also at this time, a hysteresis characteristic may be provided in a range where each constant varies.

As shown in FIG. 13 and FIG. 14, each of the above-mentioned constants is set based on highest value EGY of respective power consumptions of data drivers 42(1) through 42(16). When the power consumptions of data drivers 42(1) through 42(16) are large, the value of each constant is set to be large, the application range of an image signal using a coding table having a small number of combinations of the subfields is enlarged, and driving is performed while suppression of the power consumptions is prioritized. When the power consumptions of data drivers 42(1) through 42(16) are small, the value of each constant is set to be small, the number of displayable gradations is increased, and driving is performed while the image display performance is prioritized.

In the present embodiment, constant BRT and constants Mr, Mg, and Mb have been described to have predetermined values. However, the present invention is not limited to this. These constants BRT, Mr, Mg, and Mb may be set based on highest value EGY of the power consumptions of data drivers 42(1) through 42(16).

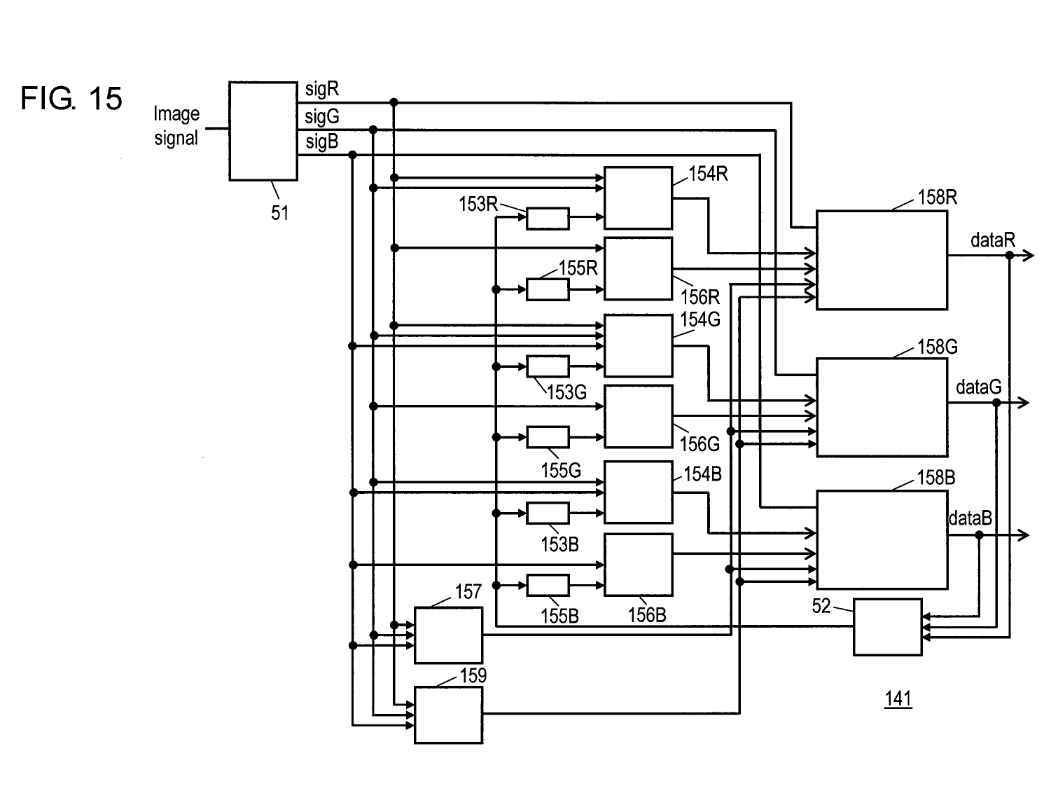

Next, the configuration of an image signal processing circuit of the second exemplary embodiment is described in detail. FIG. 15 is a circuit block diagram showing the detail of image signal processing circuit 141 in accordance with the second exemplary embodiment of the present invention. Image signal processing circuit 141 has color separating section 51, power predicting section 52, Kr setting section 153R, Kg setting section 153G, Kb setting section 153B, R comparing section 154R, G comparing section 154G, B comparing section 154B, Cr setting section 155R, Cg setting section 155G, Cb setting section 155B, R differential section 156R, G differential section 156G, B differential section 156B, motion detecting section 157, R data converting section 158R, G data converting section 158G, B data converting section 158B, and dark image detecting section 159.

Color separating section 51 and power predicting section 52 are the same as color separating section 51 and power predicting section 52 of the first exemplary embodiment, and hence are not described.

Dark image detecting section 159 determines luminance conversion signal sigY by multiplying each of red image signal sigR, green image signal sigG, and blue image signal sigB by a coefficient proportional to the luminance. Dark image detecting section 159 compares luminance conversion signal sigY with constant BRT, and outputs the comparison result of either of dark image and bright image to R data converting section 158R, G data converting section 158G, and B data converting section 158B.

Kr setting section 153R outputs constants Kr1 and Kr2 shown in FIG. 13 based on highest value EGY of the power consumptions. R comparing section 154R compares a constant value times green image signal sigG with red image signal sigR using constants Kr1 and Kr2. R comparing section 154R outputs a comparison result, namely high signal level, intermediate signal level, or low signal level, to R data converting section 158R.

Kg setting section 153G and G comparing section 154G, and Kb setting section 153B and B comparing section 154B are operated similarly to Kr setting section 153R and R comparing section 154R, respectively.

Cr setting section 155R outputs constant Cr shown in FIG. 14 based on highest value EGY of the power consumptions. R differential section 156R calculates spatial difference of red image signal sigR using constant Cr, and outputs a comparison result, namely large spatial difference or small spatial difference, to R data converting section 158R.

Cg setting section 155G and G differential section 156G, and Cb setting section 155B and B differential section 156B are operated similarly to Cr setting section 155R and R differential section 156R, respectively.

Motion detecting section 157 has frame memory and a differential circuit, for example. Motion detecting section 157 calculates the difference between frames, as the time difference, and detects an image as moving image when the absolute value is a predetermined value or more, or detects the image as still image when the absolute value is smaller than the predetermined value. Motion detecting section 157 outputs the detection result to R data converting section 158R, G data converting section 158G, and B data converting section 158B.

R data converting section 158R converts red image signal sigR into red image data dataR using the coding tables shown in FIG. 10A, FIG. 10B, FIG. 10C, FIG. 10D, FIG. 10E, and FIG. 10F based on the following parameters: the detection result of dark image detecting section 159; the comparison result of R comparing section 154R; the result of spatial difference of R differential section 156R; and the motion detection result of motion detecting section 157. Similarly, G data converting section 158G converts green image signal sigG into green image data dataG, and B data converting section 158B converts blue image signal sigB into blue image data dataB.

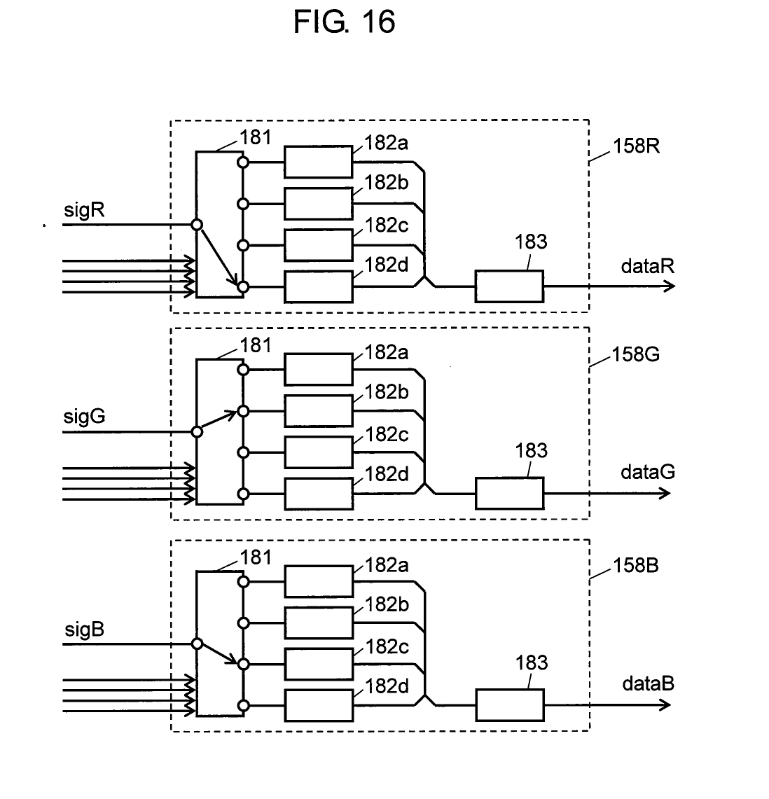

FIG. 16 is a circuit block diagram of R data converting section 158R, G data converting section 158G, and B data converting section 158B of plasma display device 40 in accordance with the second exemplary embodiment of the present invention. R data converting section 158R has coding selecting section 181, four coding tables 182a, 182b, 182c, and 182d, and error diffusion processing section 183.

Coding selecting section 181 selects one from four coding tables 182a, 182b, 182c, and 182d based on the detection result of dark image detecting section 159, the comparison result of R comparing section 154R, the result of spatial difference of R differential section 156R, and the detection result of motion detecting section 157. Each of coding tables 182a, 182b, 182c, and 182d is constituted using a data converting table in a read only memory (ROM) or the like, and converts input red image signal sigR into red image data dataR. Error diffusion processing section 183 is disposed for falsely displaying a gradation that cannot be displayed on the coding tables, applies error diffusion processing and dither processing to the red image data, and outputs the processed red image data as red image data dataR.

G data converting section 158G and B data converting section 158B have a configuration similar to that of R data converting section 158R, and hence are not described.

Such a configuration can provide a panel driving method capable of reducing electric power without sacrificing the image display quality, and a plasma display device using the driving method.

The number of coding tables is four in the second embodiment; however, the present invention is not limited to this. A plurality of coding tables other than them may be switched and used. A coding table used for the image signal of each color may be selected based on the spatial difference of the image signal of each color and power consumptions of data drivers. The relative signal level of the image signal of each color may be added as a selecting condition of the coding table.

In the present invention, the number of subfields and luminance weight of each subfield are not limited to the above-mentioned values. The specific numerical values or the like used in the first and second exemplary embodiments are simply one example, and are preferably set to the optimal values according to the characteristic of the panel or the specification of the plasma display device.

### INDUSTRIAL APPLICABILITY

The present invention can reduce the power consumption of a data electrode driving circuit without sacrificing the image display quality, and hence is useful as a driving method of a plasma display device.

### REFERENCE MARKS IN THE DRAWINGS

10 panel
22 scan electrode
23 sustain electrode
24 display electrode pair
32 data electrode
40 plasma display device
41, 141 image signal processing circuit
42 data electrode driving circuit
42(1)-42(16) data driver
43 scan electrode driving circuit
44 sustain electrode driving circuit
45 timing generating circuit
51 color separating section
52 power predicting section
53R, 153R Kr setting section
53G, 153G Kg setting section
53B, 153B Kb setting section
54R, 154R R comparing section
54G, 154G G comparing section
54B, 154B B comparing section
58R, 158R R data converting section
58G, 158G G data converting section
58B, 158B B data converting section
61(1)-61(16) driver power calculating section
62(1)-62(16) driver power accumulating section
63 maximum value selecting section
81,181 coding selecting section
82a, 82b, 182a, 182b, 182c, 182d coding table
155R Cr setting section
155G Cg setting section
155B Cb setting section
156R R differential section
156G G differential section
156B B differential section
157 motion detecting section
159 dark image detecting section
183 error diffusion processing section
sigB blue image signal
sigG green image signal
sigR red image signal

1. A driving method of a plasma display device that has a plasma display panel including a plurality of discharge cells having a data electrode, and a data electrode driving circuit for applying an address pulse to the data electrode, the address pulse controlling light emission or no light emission in the discharge cells, the driving method comprising:
constituting one field period by a plurality of subfields of a predetermined luminance weight;
selecting a plurality of combinations from arbitrary combinations of the subfields and creating a combination set for display; and
displaying gradation by controlling the light emission or no light emission in the discharge cells using a combination of the subfields belonging to the combination set for display,
wherein a plurality of combination sets for display having a different number of combinations is provided,
wherein respective signal levels of a red image signal, a green image signal, and a blue image signal are compared with each other,
wherein a combination set for display is used for an image signal of a color that has a relatively low signal level, the number of combinations in the combination set for display being smaller than that in a combination set for display used for an image signal of a color that has a relatively high signal level, and
wherein, when the power consumption of the data electrode driving circuit is large, a combination set for display is used where the number of combinations is smaller than that in a combination set for display used for an image signal when the power consumption of the data electrode driving circuit is small.

2. A driving method of a plasma display device that has a plasma display panel including a plurality of discharge cells having a data electrode, and a data electrode driving circuit for driving the data electrode, the driving method comprising:
constituting one field period by a plurality of subfields of a predetermined luminance weight;
selecting a plurality of combinations from arbitrary combinations of the subfields and creating a combination set for display; and
displaying gradation by controlling light emission or no light emission in a discharge cell using a combination of the subfields belonging to the combination set for display,
wherein a plurality of combination sets for display having a different number of combinations is provided,
wherein respective spatial differences of a red image signal, a green image signal, and a blue image signal are calculated,
wherein a combination set for display is used for an image signal having a large spatial difference, the number of combinations in the combination set for display being smaller than that in a combination set for display used for an image signal having a small spatial difference, and
wherein, when the power consumption of the data electrode driving circuit is large, a combination set for display is used where the number of combinations is smaller than that in a combination set for display used for an image signal when the power consumption of the data electrode driving circuit is small.

3. The driving method of a plasma display device of claim 1, wherein
the average value of hamming distances between certain gradations and the next smaller gradations in a combination set for display that has a small number of combinations is smaller than the average value of hamming distances between certain gradations and the next smaller gradations in a combination set for display that has a large number of combinations.

4. The driving method of a plasma display device of claim 1, wherein
a combination set for display is used for an image signal for displaying a moving image, the number of combinations in the combination set for display being smaller than that in a combination set for display used for an image signal for displaying a still image.

5. The driving method of a plasma display device of claim 2, wherein
the average value of hamming distances between certain gradations and the next smaller gradations in a combination set for display that has a small number of combinations is smaller than the average value of hamming distances between certain gradations and the next smaller gradations in a combination set for display that has a large number of combinations.

6. The driving method of a plasma display device of claim 2, wherein
a combination set for display is used for an image signal for displaying a moving image, the number of combinations in the combination set for display being smaller than that in a combination set for display used for an image signal for displaying a still image.
